(19) United States
(12) Patent Application Publication
(10) Pub. No.: US 2025/0350322 A1
(43) Pub. Date: Nov. 13, 2025

(54) METHOD AND SYSTEM FOR WIRELESS AND FRONTHAUL SCHEDULING TO SUPPORT UPLINK COORDINATED MULTIPOINT IN 6G

(71) Applicant: Indian Institute of Technology Kharagpur, Kharagpur (IN)

(72) Inventors: Sourabh Sunil BHANDARKAR, Kharagpur (IN); Preeti Samhita PATI, Kharagpur (IN); Nikita MUNDU, Kharagpur (IN); Sourav DUTTA, Kharagpur (IN); Goutam DAS, Kharagpur (IN)

(21) Appl. No.: 19/085,015

(22) Filed: Mar. 20, 2025

(30) Foreign Application Priority Data
May 11, 2024 (IN) 202431037310

(51) Int. Cl. H04B 7/024; H04B 10/27

(52) U.S. Cl. CPC H04B 7/024; H04B 10/27

(57) ABSTRACT

Provided is a system and method for joint optimization of wireless access and fronthaul in uplink scheduling of Coordinated Multipoint (COMP) users. The system comprises one or more user equipments (UE), two or more Optical Network Units (ONU), and at least one Optical Line Terminal (OLT). Wherein each ONU is communicably coupled with one RRH and comprises a first processing unit, and a buffer unit. Each of the RRHs transmits the received signal to the ONU via enhanced Common Public Radio Interface (eCPRI). The at least one OLT is collaboratively connected with the two or more ONUs, wherein the at least one OLT comprises a second processing unit and a playout buffer. The second processing unit processes Ethernet frames as received at the OLT from the at least pair of the ONUs from the corresponding COMP user, for retrieving the eCPRI frames and the playout buffer minimizes the jitter.

### TECHNICAL FIELD

The present disclosure relates to wireless networks. Particularly, but not exclusively, the present disclosure is directed towards a method and system for wireless and fronthaul scheduling to support uplink Coordinated Multipoint (COMP) in 6G.

### BACKGROUND

In the past, the 3rd Generation Partnership Project (3GPP) group proposed Coordinated Multipoint (COMP) as an efficient technique for managing intercell interference (ICI) and increasing the throughput of cell edge users. The efficiency is increased by synchronizing data transmission among multiple adjacent cells, thereby improving high data rate coverage. Coordinating base stations communicate over the X2 interface, thereby synchronizing the data transmission among them.

FIG. 1 illustrates a Joint Reception (JR), i.e. uplink COMP scenario, where User Equipment 1 (UE1) is identified as a cell edge user with potentially poor channel conditions, in accordance with the existing art.

As shown in FIG. 1, UE1 transmits uplink data to its associated base station, BS1, and the adjacent BS2 on the same resource block to mitigate interference. This prevents signal interference with BS2, especially in full-frequency reuse schemes. BS1 and BS2 exchange UE1 data via the X2 interface for joint processing, optimizing performance. An advent of next-generation networks has directed researchers and industry towards centralized processing, as seen in Cloud-Radio Access Networks (C-RAN). The 5GPPP proposed the C-RAN design as a feasible approach to enhance real-time network cooperative processing gain. Hence, the C-RAN can support the CoMP technique. In the C-RAN, the centralized or Baseband unit (BBU) pool performs baseband processing and radio frequency functionalities at the Remote Radio Heads (RRHs). This necessitates a high-bandwidth fronthaul (FH) link, with the primary challenge being precise synchronization for effective COMP coordination. So, the FH link could be of TWDM-EPON. Again, this poses challenges in optical wavelength availability and time slot coordination for scheduling.

In a conventional non-patent literature, Li-Hsiang Shen; Yung-Ting; Huang; Kai-Ten Feng in “CoMP-Enhanced Flexible Functional Split for Mixed Services in Beyond 5G Wireless Networks,” in IEEE Transactions on Communications, vol. 71, no. 7, pp. 4133-4150, July 2023, propose a CoMP-enhanced Functional Split-Mode Allocation (CFSMA) scheme. The CFSMA scheme optimizes system spectrum efficiency while guaranteeing stringent latency requirements in a C-RAN 5G system. However, the non-patent literature fails to consider the constraints on the fronthaul (FH) network scheduling.

In another conventional non-patent literature, Aziza Zaouga; Amaro F. de Sousa; Monia Najjar; Paulo Pereira Monteiro in “Self-Adjusting DBA Algorithm for Next Generation PONs (NG-PONs) to Support 5G Fronthaul and Data Services,”, Journal of Lightwave Technology, vol. 39, no. 7, pp. 1913-1924, 1 Apr. 1, 2021 disclose a novel DBA algorithm for NG-PON networks to jointly support 5G fronthaul and best-effort data services in the same PON channel. In this literature, it is observed that there are high packet delays at the beginning of each 5G fronthaul connection, whereas it is necessary to satisfy stringent delay requirements to support current network needs.

In yet another conventional non-patent literature, Jiawei Zhang; Yuming Xiao; Dexue Song; Lin Bai; Yuefeng J in “Joint Wavelength, Antenna, and Radio Resource Block Allocation for Massive MIMO Enabled Beamforming in a TWDM-PON Based Fronthaul,” in Journal of Lightwave Technology, vol. 37, no. 4, pp. 1396-1407, 15 Feb. 15, 2019, disclose optimization of the fronthaul bandwidth and radio RB resource utilization. However, the idea in the prior art does not impose any constraints on the number of optical wavelengths utilised in the uplink FH network. Imposing these constraints will break the chain created by several coordinating base stations in the uplink, thus significantly affecting the total data rate of the wireless access network.

In yet another conventional non-patent literature, Ahmed Mohammed Mikaeil; Weisheng Hu; Longsheng Li in “Joint Allocation of Radio and Fronthaul Resources in Multi-Wavelength-Enabled C-RAN Based on Reinforcement Learning,”, Journal of Lightwave Technology, vol. 37, no. 23, pp. 5780-5789, 1 Dec. 1, 2019 propose a reinforcement learning based scheduling algorithm to address the complexity of the uplink resource allocation problem in multi-wavelength C-RAN architecture. However, the conventional literature does not restrict the number of wavelengths in the uplink which is an infeasible strategy.

In yet another conventional non-patent literature, Jiawei Zhang; Yuefeng Ji; Songhao Jia; Hui Li; Xiaosong Yu; Xinbo Wang in “Reconfigurable optical mobile fronthaul networks for coordinated multipoint transmission and reception in 5G,” in Journal of Optical Communications and Networking, vol. 9, no. 6, pp. 489-497, June 2017 disclose reconfigurability of TWDM-PON-based fronthaul that can improve the COMP service in a C-RAN system through elastic radio resource allocation.

In a conventional patent literature, WO2020221430A1 titled “Method and apparatus for controlling transmission of an upstream packet traffic in a tdm pon-based fronthaul” discloses method and system for controlling upstream packet transmission in a TDM-PON based C-RAN scenario. However, the prior art does not consider fronthaul feasibility constraints in a TDM-PON network.

In another conventional patent literature, U.S. Pat. No. 9,813,205B2 titled “Uplink CoMP set selecting method and system, and device” provides an uplink coordinated multipoint transmission (CoMP) set selecting method, system, and device that allows base stations to exchange at least channel state information-reference signal (CSI-RS) configuration information used to distinguish cells. However, the patent literature does not consider CRAN which is most significant architecture as it provides flexibility, robustness, and scalability to access networks.

Thus, there is a requirement that addresses one or more above-mentioned challenges with a novel system and method explained in the subsequent disclosures.

### SUMMARY

One or more shortcomings of the prior art are overcome, and additional advantages are provided through the present disclosure. Additional features and advantages are realized through the techniques of the present disclosure. Other embodiments and aspects of the disclosure are described in detail herein and are considered a part of the claimed disclosure.

The present disclosure relates to a system for joint optimization of wireless access and fronthaul in uplink scheduling of Coordinated Multipoint (COMP) users. The system comprises one or more user equipments (UE), two or more Optical Network Units (ONU), and at least one Optical Line Terminal (OLT). Each UE is associated with at least a pair of coordinating Remote Radio Heads (RRH). Wherein each ONU is communicably coupled with one RRH and comprises a first processing unit, and a buffer unit. Each of the RRHs, upon receipt of user signal from the associated UE, transmits the received signal to the ONU via enhanced Common Public Radio Interface (eCPRI). The at least one Optical Line Terminal (OLT) is collaboratively connected with the two or more ONUs, wherein the at least one OLT comprises a second processing unit and a playout buffer. The second processing unit is configured to process Ethernet frames as received at the OLT from the at least pair of the ONUs from the corresponding COMP user, in order to retrieve the eCPRI frames and the playout buffer is configured to minimize the jitter. In one embodiment, association between each UE with the respective at least pair of RRH is determined on basis of channel condition of the respective UE to each of the at least pair of RRH.

In another embodiment, the present disclosure relates to a method for joint optimization of wireless access and fronthaul in uplink scheduling of Coordinated Multipoint (CoMP) users. The method comprises allocating with same resource block group to each of the COMP user by both of at least pair of coordinating RRH, for aiding the COMP user to transmit the same signal through multiple ONUs coupled with the RRHs. The method further comprises step of performing wavelength and slot allocation for each ONU at beginning of every polling cycle, wherein the polling cycle is predefined with fixed number of slots and number of wavelengths considering a Time and Wavelength Division Multiplexing (TWDM) system for enabling simultaneous transmission of COMP which requires synchronization in the fronthaul, by simultaneously scheduling multiple ONUs in the same slot.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DRAWINGS

The novel features and characteristics of the disclosure are set forth in the appended claims. The disclosure itself, however, as well as a preferred mode of use, further objectives, and advantages thereof, will best be understood by reference to the following detailed description of an illustrative embodiment when read in conjunction with the accompanying figures. One or more embodiments are now described, by way of example only, with reference to the accompanying figures wherein like reference numerals represent like elements and in which:

FIG. 1 illustrates a Joint Reception (JR), i.e. uplink COMP scenario, where User Equipment 1 (UE1) is identified as a cell edge user with potentially poor channel conditions, in accordance with the existing art;

FIG. 2 illustrates Time Wavelength Division Multiplexing-Passive Optical Network (TWDM-EPON) for the fronthaul arrangement, in accordance with the existing art;

FIG. 3 illustrates architecture and framework of protocols for sending data from users to the BBU pool, in accordance with an embodiment of the present disclosure;

FIG. 4 illustrates a schematic block diagram of proposed changes in the MPCP Gate message and associated system to maintain synchronization, in accordance with an embodiment of the present disclosure;

FIG. 5 illustrates a timing diagram for precise synchronous UL forwarding of CoMP user data copies from the corresponding COMP set via FH, in accordance with an embodiment of the present disclosure;

FIG. 6 illustrates a time cycle diagram indicating faithful reconstruction with the delay bound, in accordance with an embodiment of the present disclosure;

FIG. 7 illustrates a schematic diagram of UL COMP scheduling with and without fronthaul constraints, in accordance with an embodiment of the present disclosure;

FIG. 8 illustrates a flow diagram of a method for UL COMP scheduling considering fronthaul constraints, in accordance with an embodiment of the present disclosure; and

FIG. 9 illustrates an exemplary percentage gain in total network throughput comparing random ONU scheduling and proposed scheduling technique vs number of optical wavelengths (λ) and time slot (TS) in FH grid with 50 Users and 16 RRHs scenario, in accordance with an embodiment of the present disclosure; and

FIG. 10 illustrates an exemplary percentage gain in total COMP throughput comparing random ONU scheduling and proposed scheduling technique vs users (considering Fronthaul Constraint of 4 optical wavelengths and 16 RRHs scenario), in accordance with an embodiment of the present disclosure;

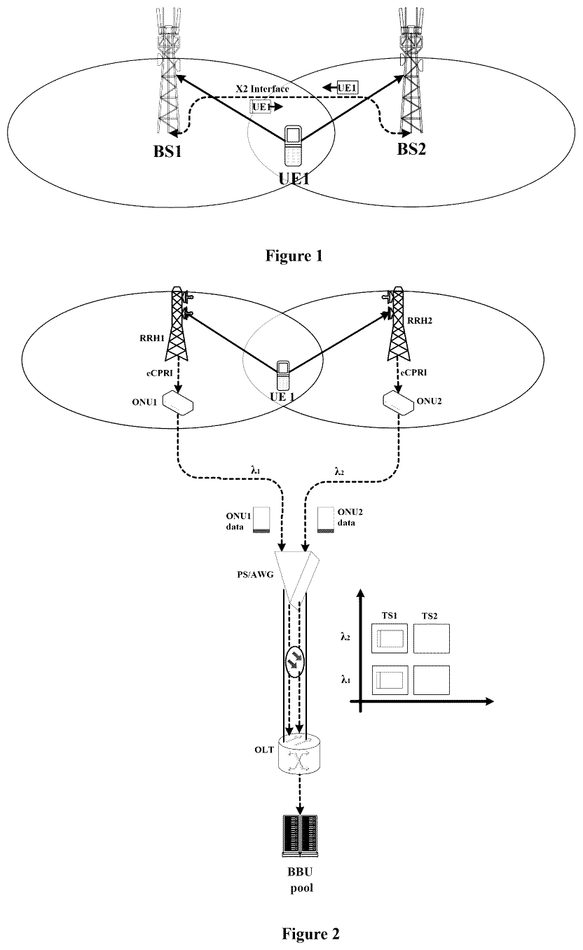

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however, that it is not intended to limit the disclosure to the forms disclosed, but on the contrary, the disclosure is to cover all modifications, equivalents, and alternatives falling within the spirit and the scope of the disclosure.

The terms “comprises”, “comprising”, or any other variations thereof, are intended to cover a non-exclusive inclusion, such that a setup, device, or process that comprises a list of components or steps does not include only those components or steps but may include other components or steps not expressly listed or inherent to such setup or device or process. In other words, one or more elements in a system or apparatus proceeded by “comprises . . . a” does not, without more constraints, preclude the existence of other elements or additional elements in the system or apparatus.

In the following detailed description of the embodiments of the disclosure, reference is made to the accompanying drawings that form a part hereof, and which are shown by way of illustration-specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

Coordinated Multipoint Transmission (COMP) has already been recognized by the 3GPP group as one of the essential use cases for 5G and beyond. A primary objective of COMP techniques is to maintain precise synchronization and coordination between multiple RRHs to receive signals simultaneously from UE but on the same resource block. Considering the 6G centralized network architecture, most of the processing happens in the centralized unit, leading to higher bandwidth requirements of the fronthaul link connecting RRH to the CU/BBU pool. Time Wavelength Division Multiplexing-Passive Optical Network (TWDM-EPON) is a suitable choice for the fronthaul arrangement, which is illustrated in FIG. 2, in accordance with the existing art. However, it has to satisfy the major constraint that the coordinating RRHs must be scheduled in the same time-slot so that the COMP user data copies reach the BBU pool end at the same time, thereby preventing the asynchronous uplink forwarding in the FH. As the number of wavelengths is limited, it is required to jointly consider the wireless access and fronthaul network to optimize data rate and reliability of the COMP state-of-the-art technology.

It is identified that there is a dependency on sum data rate of the wireless access network and number of FH optical wavelengths in a TWDM-PON based Cloud-Radio Access Network (C-RAN) model for 6G networks. It is imperative to note that to support Uplink (UL) transmission in COMP, precise synchronization has to be maintained in the FH while uplink forwarding of COMP user data copies from Coordinating Remote Radio Heads (RRHs) through the respective Optical Network Units (ONUs) to the Baseband unit (BBU) end for joint processing. In order to demonstrate efficacy in addressing aforementioned issue, a method and system solve the problem of joint user association, resource block allocation and slot allocation optimization problem for JR or UL COMP operation using the C-RAN model that maximizes the sum data rate of the network subject to wireless access and FH network constraints. The present disclosure discloses necessary changes in ONU node as well as Multi-Point Control Protocol (MPCP) Gate message and associated system so that precise synchronization is maintained. Moreover, cycle time modification helps us achieve faithful reconstruction of signals at ONU including HARQ retransmissions. Thus, it suggests system-level modifications in the Media Access Control (MAC) layer.

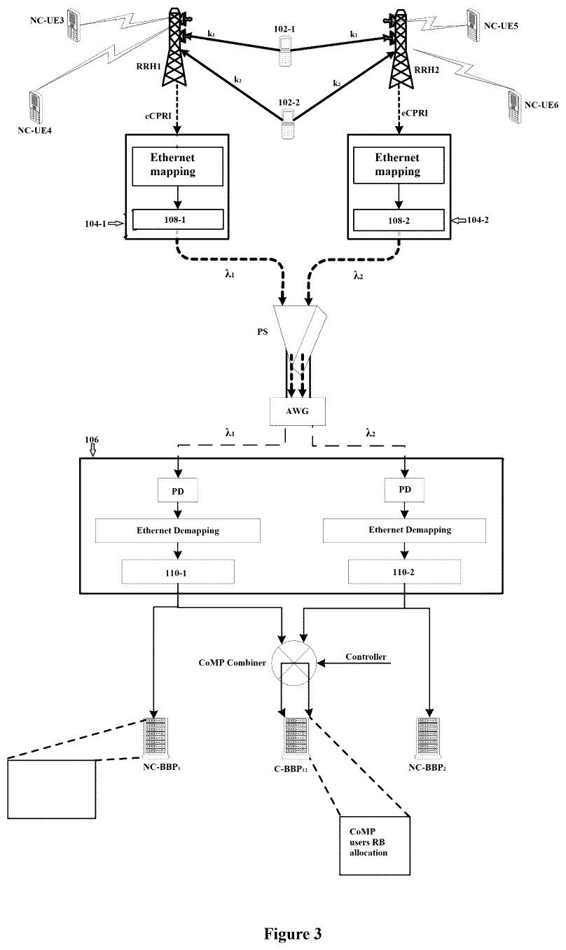

FIG. 3 illustrates architecture and framework of protocols for sending data from users to the BBU pool, in accordance with an embodiment of the present disclosure.

As mentioned, the JR COMP technique is considered in dense urban scenarios using C-RAN architecture. Starting with the wireless access network side, a first problem is user association. The user association with a particular RRH means that the user transmits its data to its intended or associated RRH. Now, the COMP scenario is considered in which the user can be associated with more than one RRH called a COMP user. And the other users are known as non-COMP users.

As in FIG. 3, the proposed system for joint optimization of wireless access and fronthaul in uplink scheduling of Coordinated Multipoint (COMP) users is illustrated. The system comprises one or more user equipments (UE) (102-1, 102-2, hereinafter referred to as 102), two or more Optical Network Units (ONU) (104-1, 104-2, hereinafter referred to as 104), and at least one Optical Line Terminal (OLT) (106). Each UE (102) is associated with at least a pair of coordinating Remote Radio Heads (RRH). Each ONU (104) is communicably coupled with one RRH and comprises a first processing unit, and a buffer unit (108, combinedly referring to 108-1, 108-2). Each of the RRHs, upon receipt of user signal from the associated UE (102), transmits the received signal to the ONU (104) via enhanced Common Public Radio Interface (eCPRI). The at least one Optical Line Terminal (OLT) (106) is collaboratively connected with the two or more ONUs, wherein the at least one OLT comprises a second processing unit and a playout buffer (110, combinedly referring to 110-1, 110-2). The second processing unit is configured to process Ethernet frames as received at the OLT from the at least pair of the ONUs from the corresponding COMP user, in order to retrieve the eCPRI frames and the playout buffer (110) is configured to minimize the jitter. The association between each UE with the respective at least pair of RRH is determined on basis of channel condition of the respective UE to each of the at least pair of RRH.

Each of the COMP user is allocated with same resource block by both of the at least pair of coordinating RRH, in order to enable the COMP user to transmit the same signal through multiple ONUs coupled with the RRHs. In one embodiment, the first processing unit of each ONU is configured to map the received signal from the respective RRH to an Ethernet frame, and the buffer unit (108) is configured to buffer the received Ethernet frame at the respective ONU. In another embodiment, the second processing unit of the at least one OLT (106) is configured to perform wavelength and slot allocation for each ONU at beginning of every polling cycle. The polling cycle is predefined with fixed number of slots and number of wavelengths considering a Time and Wavelength Division Multiplexing (TWDM) system for enabling simultaneous transmission of COMP which requires synchronization in the fronthaul, by simultaneously scheduling multiple ONUs (104) in the same slot.

Further, upon performing the wavelength and slot allocation, the second processing unit of the OLT is further configured to communicate the ONUs to transmit the buffered Ethernet frames at specified start time so as to receive the same Ethernet frames at OLT to maintain precise synchronization. The second processing unit of the OLT further determines differential delay arising out of the varying geographical locations of the ONUs from OLT, and adjusts the differential delay with the help of the buffer unit at the ONU through GATE message modification in existing MPCP protocol.

In an exemplary embodiment, as shown in FIG. 3, CoMP-User Equipment i.e. C-UE1 and C-UE2, are the COMP users, whereas NC-UE3, NC-UE4, NC-UE5 and NC-UE6 are non-COMP users. User association is basically done on the basis of the channel condition of that particular user to that RRH. So, in this exemplary embodiment, C-UE1 is far from the RRH1 and RRH2; hence may be justified as a COMP user. It is pertinent to note that user channel condition does not depend only on the distance parameter i.e. (Pathloss effect), but it also includes fading effect. As C-UE1 is a COMP user, which is associated with set of two RRHs i.e. RRH1 and RRH2, so this set of RRHs is called a COMP set of user C-UE1. A main constraint of wireless RA is that if the user is a COMP user, then it has to be allocated the same resource block by both the coordinating RRH. In this exemplary embodiment, the COMP user C-UE1 is allocated with k1 resource block when transmitting data to RRH1 and RRH2. Similarly, C-UE2 transmits data to RRH1 and RRH2 over resource block k2, achieving diversity benefit.

Now, after user association is completed, the next problem is wireless RA i.e. resource block allocation to all the users associated with their respective RRH. If the user is a COMP user (C-UE1 and C-UE2), then the data is sent to all its connected RRHs, while for the non-COMP user, data is sent to a single RRH. It is pertinent to note that if a resource block is allocated to a user, then the user sends data over the entire TTI duration using this resource block.

Moving to the FH part of the network, the main issue is wavelength and time slot allocation. The RRH receives user data and sends it to the ONU via eCPRI, which is then mapped to an Ethernet frame. Since a COMP user transmits the same data through multiple ONUs, there are different propagation delays, meaning that the same Ethernet frame of that user reaches the OLT at different times. Therefore, the Ethernet frame must be buffered either at the OLT or ONUs. In this study, differential delay management is performed at ONUs by storing them in a buffer. Next, the scheduling at the fronthaul is disclosed.

An allowable delay at the front haul is Oms. Thus, a polling-based protocol cannot be employed to enable dynamic bandwidth allocation. For polling-based protocol, the upstream (US) data may need to wait for a complete polling cycle before sending the REPORT message, and then scheduling is performed. Thus, a fixed bandwidth allocation protocol is considered in the present disclosure. In order to do so, it is assumed that every polling cycle is divided into some fixed number of slots and a slot is allocated to an ONU. These slots for every wavelength are synchronized at the OLT. The OLT performs the slot allocation for every ONUs at the beginning of every polling cycle. After performing the slot allocation, the OLT informs the ONUs when to start the data transmission using the GATE message. Let i^{th} slot be assigned to ONUₖ and start time of i^{th} slot at the OLT is tis. If T^{k}ᵣ denotes the round-trip time of ONUₖ then it starts data transmission at tⁱₛ−(T^{k}ᵣ)/2. Further, let us assume that u^{th} user is a COMP user which transmits its US data through ONUₚ and ONU_{q}. If ONUₚ and ONU_{q} are allocated with the same slot of two different wavelengths, then US data of u^{th} user reaches the OLT exactly at the same time, and hence, they can be combined to achieve diversity gain. However, if ONUₚ and ONU_{q} are allocated with different slots, then different copies of u^{th} user's US data arrive at different times then buffering of these earlier arrived copies is required. This introduces additional delay along with requiring a playoff buffer at the OLT. To avoid this, in this study, we assume that if a COMP user is allocated with a resource block and it transmits through multiple ONUs, then all such ONUs are assigned same time slot of different wavelengths. Clearly, the fronthaul scheduling is dependent on which user is scheduled (i.e., allocated with a resource block), but it is independent of which resource block at which a user is scheduled. Thus, the framework of the proposed method is as follows:
a. At the beginning of every polling cycle, the OLT, with the help of BBU (i.e., the OLT and BBU communicate through the control channel), decides which users are of an RRH (i.e., ONU) will be allocated with a resource block and at which wavelength and slot the ONU send its US data. While doing so, the OLT must ensure that if a COMP user is scheduled, all ONUs through which it transmits US traffic should be assigned the same slot.
b. The BBU then tries to allocate a resource block to the maximum number of scheduled users (decided by the previous step). While allocating a resource block, the BBU must ensure that the same resource block will be allocated to a COMP user in all RRHs through which it transmits US data.

### Modification in Protocol Stack

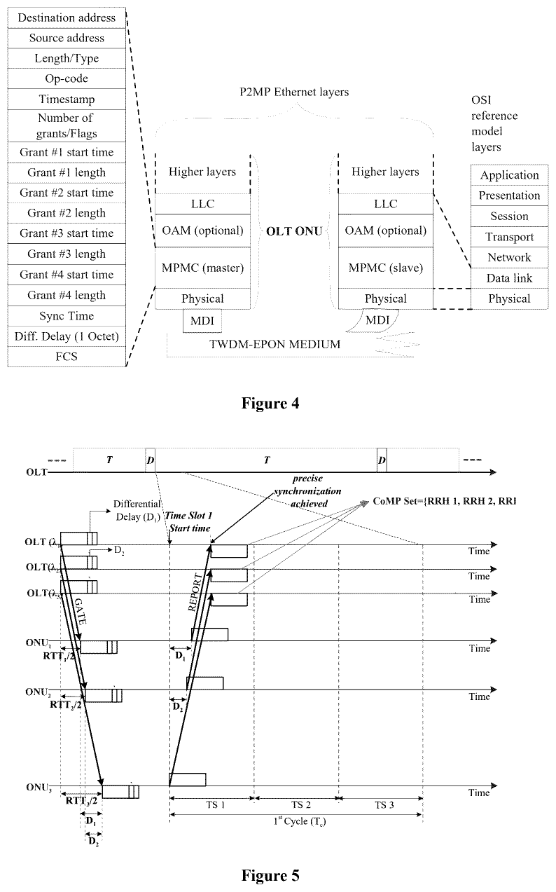

FIG. 4 illustrates a schematic block diagram of proposed changes in the MPCP Gate message and associated system to maintain synchronization, in accordance with an embodiment of the present disclosure.

As shown on the left-hand side in FIG. 4, which is an MPCP Gate message format, one of the field names, “Diff. delay” i.e. differential delay is highlighted. In general, this is a reserved field, so this field is used to share the differential delay of the respective ONU, which is part of the given COMP set. By doing so, their propagation delay is adjusted such that the uplink forwarded REPORT message reaches OLT at the same time, thereby maintaining precise synchronization. A detailed process is explained in FIG. 5 of the present disclosure.

FIG. 5 illustrates a timing diagram for precise synchronous UL forwarding of COMP user data copies from the corresponding COMP set via FH, in accordance with an embodiment of the present disclosure.

Starting with the OLT, which receives information from the BBU pool about the ONUs associated with the given COMP set. Then, accordingly, the ONUs are scheduled by the OLT in the same time slot (TS) but on a different wavelength. Also, the OLT knows the round-trip time (RTT) of all the ONUs through the registration process. So, it calculates the difference between the propagation delay of all the ONUs in that particular COMP set and the one with the maximum propagation delay. Then, this differential delay is stored in the respective GATE message. So, for example, in FIG. 5, RRH 1, RRH 2 and RRH 3 form a COMP set. Among them, ONU 3 (Note: here, ONU 3 is connected to RRH 3; similarly, other RRHs have their individual ONUs) has the maximum propagation delay. Therefore, ONU 1 has to wait for D1 (i.e. the ONU 1 differential delay time) amount of time from the reference point, which is the TS 1 start time, before any uplink forwarding of the data to the OLT. Similarly, other ONUs of that COMP set are scheduled so that their data copies arrive at the OLT at the same time, thereby achieving precise synchronisation.

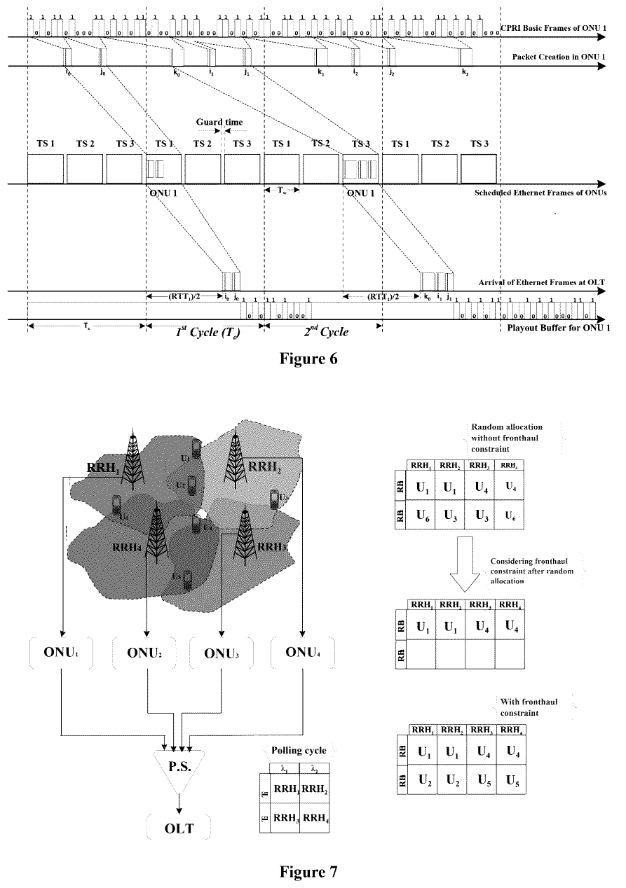

FIG. 6 illustrates a time cycle diagram indicating faithful reconstruction with the delay bound, in accordance with an embodiment of the present disclosure.

Here, the fixed time slot and variable time slot scheduling for ONUs in the uplink are disclosed. There is a stringent requirement on delay bound at the MAC layer. If fix time slot location is allocated for all ONUs, then this may be avoided. However, there will be inefficiency in bandwidth utilization. Thus, variable time slot scheduling is considered. FIG. 6 illustrates worst-case delay in the timing diagram for this scenario. A delay bound of twice the cycle time may be kept. This gives the flexibility to schedule any particular ONU at any time slot in the cycle.

According to an exemplary embodiment, the time cycle is discussed as follows:
a. The time each ONU waits between two consecutive slots is cycle time minus it's own transmission slot size given by W=(2*T_{c})−T_{w}.
b. The time required for OLT to receive the whole ethernet packet of each ONU over EPON is queuing delay (T_{q}) plus fibre propagation delay (RTT/2).
c. Decapsulation time ONU includes the processing delay (T_{dc}).
d. The delay threshold (Dₜₕ) constraint for each ONU is given in equation (1):

$$( 2 * {T}_{c} - {T}_{w} ) + {T}_{q} + ( \frac{RTT}{2} ) + {T}_{d c} \leq {D}_{th} \qquad ( 1 )$$

e. Dₜₕ=246 μs including propagation delay of 100 μs length of 10 km.
f. EPON data rate=10 Gbps and eCPRI line rate=6144 Mbps.

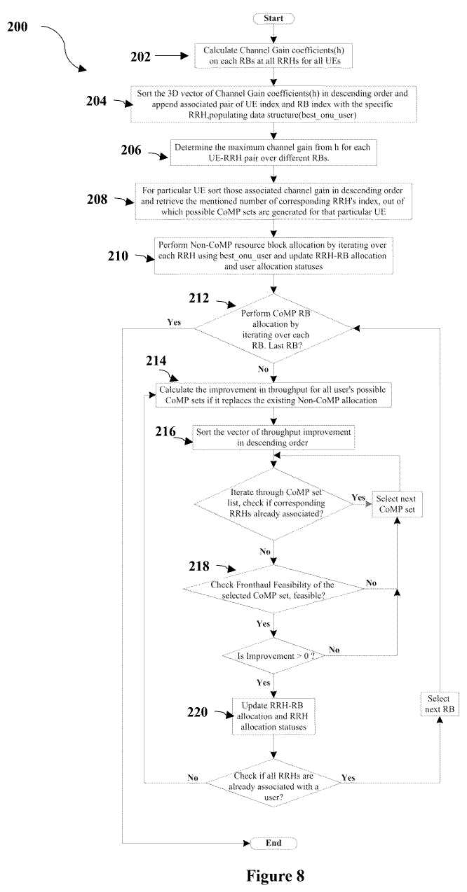

FIG. 7 illustrates a schematic diagram of UL COMP scheduling with and without fronthaul constraints, in accordance with an embodiment of the present disclosure.

The present section discloses the need for the joint optimization problem i.e., joint user association, sub-carrier (i.e. RBG) resource allocation and slot allocation. As shown in FIG. 7, a general JR COMP scenario is considered in CRAN consisting of a 2×2 grid of RRH, further connected to their respective ONUs, and ONUs are connected to OLT through a power splitter. The RRH₁ and RRH₂ are scheduled in time slot T1 with different wavelengths λ₁ and λ₂ respectively. Similarly, RRH₃ and RRH₄ are scheduled in time slot T₂ with different wavelengths λ₁ and λ₂ respectively. Each RRH has a maximum of two resource block groups (i.e. RBG₁ and RBG₂). RBG is a set of consecutive virtual resource blocks defined by the higher layer parameter. Hereinafter, the RBG is used as the basic element for scheduling and resource allocation. In this regard, two scenarios are considered:

Resource allocation without any fronthaul constraint: In a first scenario, we assume an infinite number of optical wavelengths are available. U₁, U₄, U₃ and U₆ are COMP users such that:

a. U₁ is allocated RBG₁ by RRH₁ and RRH₂.

b. U₄ is allocated RBG₁ by RRH₃ and RRH₄.

c. U₃ is allocated RBG₂ by RRH₂ and RRH₃.

d. U₆ is allocated RBG₂ by RRH₁ and RRH₄.

So, the mentioned COMP users are allocated with the same RBGs by their associated RRHs. Thereby satisfying the wireless access network COMP constraint. However, according to the given polling cycle, CoMP set (RRH₂, RRH₃) and CoMP set (RRH₁, RRH₄) cannot be scheduled in the same time slot. Therefore, precise synchronisation can not be achieved in the FH part for their respective COMP users U₃ and U₆. Hence, only COMP users U₁ and U₄ in this scenario are able to achieve overall precise synchronisation as they satisfy both the wireless access network COMP constraint and FH network constraint. In this case, the allocation is done at first, followed by fronthaul restriction consideration.

Resource allocation considering fronthaul constraint: In a second scenario, two optical wavelengths λ₁ and λ₂ are assumed. U₁ and U₂ are COMP users associated with RRH₁ and RRH₂. Similarly, U₄ and Us are COMP users associated with RRH₃ and RRH₄. In this scenario, all users U₁, U₂, U₄, and Us can be served, as it is observed in FIG. 7.

Further, it can be concluded that, from the above two scenarios, the second scenario gives a higher throughput than the first scenario. Hence, the wireless and fronthaul sections must be jointly optimized.

FIG. 8 illustrates a flow diagram of a method for UL CoMP scheduling considering fronthaul constraints, in accordance with an embodiment of the present disclosure.

A joint optimization problem is formulated for network throughput maximization by joint user association, resource block group allocation in the wireless access network and slot allocation in the FH network. However, the formulated problem is a nonlinear integer problem (NIP) and is generally considered NP-hard. Also, the complexity of the problem increases with the increase of integer variables due to the combinatorial nature of the problem. Thus, a heuristic approach is employed, wherein a user association technique is executed followed by non-COMP user resource block allocation. Lastly, COMP user resource block allocation is done considering the feasibility constraint in the fronthaul. In this regard, FIG. 8 illustrates a flow diagram of a method for UL COMP scheduling considering fronthaul constraints.

As depicted in FIG. 8, the method (200) includes a series of steps 202 through 220 for time-frequency channel estimation. The details of the method (200) have been explained below in forthcoming paragraphs. The order in which the method steps are described below is not intended to be construed as a limitation, and any number of the described method steps can be combined in any appropriate order to execute the method or an alternative method. The method (200) begins from a start block and starts execution of operations at step (202), as shown in FIG. 8.

At step (202), channel gain coefficients (h) are calculated for resource blocks groups (RBGs) across multiple Remote Radio Heads (RRHs) for one or more User Equipments (UEs).

At step (204), the channel gain coefficients are ranking in descending order, associating each coefficient with its respective UE, RBG, and RRH indices, and storing the ranking information in a ranking repository.

At step (206), the highest channel gain for each UE-RRH pair across available RBGs is identified for generating (208) prioritized COMP sets for each UE based on the highest-ranking RRHs.

At step (210), RBGs are allocated to non-COMP users by iteratively evaluating each RRH, leveraging the stored ranking repository to update RBG and UE assignment statuses.

At step (212), RBGs for COMP users are dynamically allocated by optimizing COMP set assignments based on predefined scheduling criteria and available resources.

Further, at step (214), the potential throughput improvement are analyzed for each COMP set by comparing the respective throughput against existing non-CoMP allocations.

At step (216), COMP sets are prioritized based on the evaluated throughput improvements using a descending ranking order.

At step (218), COMP sets are sequentially evaluated to determine feasibility of selected COMP sets, including checking the association status of RRHs and verifying the time slot and wavelength allocation of the respective ONUs in the fronthaul grid for each of the set.

At step (220), upon confirming feasibility and positive throughput improvement, RBG allocations and RRH assignment statuses are updated. Also, the final throughput is updated in data store and the processing is iteratively executed until all the RBGs are exhausted.

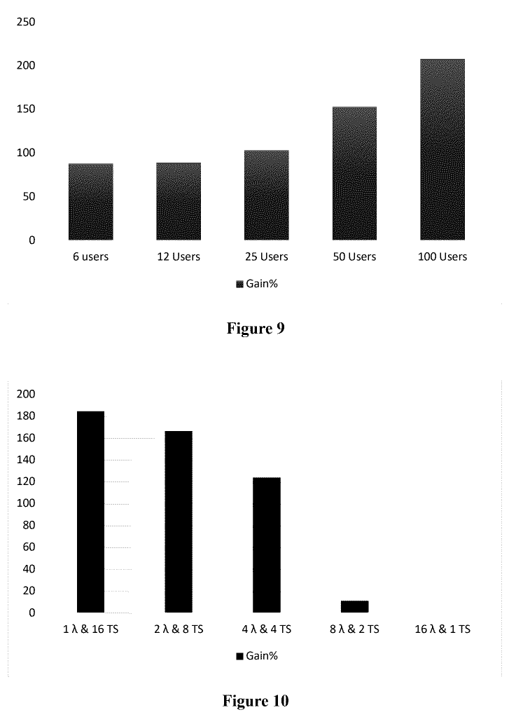

Further, FIG. 9 illustrates an exemplary percentage gain in total COMP user's throughput when comparing random allocation (later considering fronthaul constraint) and proposed technique vs users for 4 optical wavelengths and 4 time slot FH grid with 16 RRHs scenario. It is observed that our proposed algorithm outperforms the other one, i.e. random ONU Scheduling when a limited number of optical wavelengths are available in FH.

Additionally, FIG. 10 illustrates percentage gain in total network throughput when comparing random allocation (later considering fronthaul constraint) and proposed algorithm vs number of optical wavelengths (λ) and time slot (TS) in FH grid with 50 Users and 16 RRHs scenario. It is observed that our proposed technique outperforms the other one, which does not jointly consider resource allocation and slot allocation in terms of the network's total COMP throughput.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

While various aspects and embodiments have been disclosed herein, other aspects and embodiment will be apparent to those skilled in the art.

### Advantages of the Present Disclosure

The method and system for wireless and fronthaul scheduling to support uplink Coordinated Multipoint (COMP) in 6G offers several advantages over conventional technique, offering significant advancements compared to existing method and system. The advantages are as follows:
Enhancing the reliability of existing COMP state-of-the-art.
The significance of joint optimization of wireless access and fronthaul in scheduling COMP users is disclosed to better the overall network performance.
System modifications required to implement the method are provided:
   A new field is added at the MAC, requiring modification of system-level specifications; and
   Modifies the MPMC protocol for synchronization, requiring modification of system specifications.
A low-complexity method is proposed which influences the system-level modification.
Increases throughput and reliability of end users.
The method and system are cost effective.

In the detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The description is, therefore, not to be taken in a limiting sense.

We claim:

1. A system for joint optimization of wireless access and fronthaul in uplink scheduling of Coordinated Multipoint (COMP) users, the system comprises:
one or more user equipments (UE) (102-1, 102-2), wherein each UE is associated with at least a pair of coordinating Remote Radio Heads (RRH);
two or more Optical Network Units (ONU) (104-1, 104-2), wherein each ONU is communicably coupled with one RRH and comprises a first processing unit, and a buffer unit (108-1, 108-2), and each of the RRHs, upon receipt of user signal from the associated UE, transmits the received signal to the ONU via enhanced Common Public Radio Interface (eCPRI);
at least one Optical Line Terminal (OLT) (106) collaboratively connected with the two or more ONUs, wherein the at least one OLT (106) comprises a second processing unit and a playout buffer (110-1, 110-2), and the second processing unit is configured to process Ethernet frames as received at the OLT (106) from the at least pair of the ONUs from the corresponding COMP user, in order to retrieve the eCPRI frames and the playout buffer is configured to minimize the jitter;
wherein, association between each UE (102) with the respective at least pair of RRH is determined on basis of channel condition of the respective UE to each of the at least pair of RRH.

2. The system as claimed in claim 1, wherein each of the COMP user is allocated with same resource block group by both of the at least pair of coordinating RRH, thereby aiding the COMP user to transmit the same signal through multiple ONUs coupled with the RRHs.

3. The system as claimed in claim 1, wherein the first processing unit of each ONU (104) is configured to map the received signal from the respective RRH to an Ethernet frame, and the buffer unit is configured to buffer the received Ethernet frame at the respective ONU (104).

4. The system as claimed in claim 1, wherein the second processing unit of the at least one OLT (106) is configured to perform wavelength and slot allocation for each ONU at beginning of every polling cycle, wherein the polling cycle is predefined with fixed number of slots and number of wavelengths considering a Time and Wavelength Division Multiplexing (TWDM) system for enabling simultaneous transmission of COMP which requires synchronization in the fronthaul, by simultaneously scheduling multiple ONUs in the same slot.

5. The system as claimed in claim 4, wherein upon performing the wavelength and slot allocation, the second processing unit of the OLT (106) is further configured to communicate the ONUs to transmit the buffered Ethernet frames at specified start time so as to receive the same Ethernet frames at OLT (106) to maintain precise synchronization.

6. The system as claimed in claim 5, wherein the second processing unit of the OLT (106) further determines differential delay arising out of the varying geographical locations of the ONUs from OLT (106), and adjusts the differential delay with the help of the buffer unit at the ONU through GATE message modification in existing MPCP protocol.

7. A method (200) for joint optimization of wireless access and fronthaul in uplink scheduling of Coordinated Multipoint (COMP) users, the method comprises:
allocating with same resource block group to each of the COMP user by both of at least pair of coordinating RRH, for aiding the COMP user to transmit the same signal through multiple ONUs coupled with the RRHs;
performing wavelength and slot allocation, by a second processing unit of the at least one OLT, for each ONU at beginning of every polling cycle, wherein the polling cycle is predefined with fixed number of slots and number of wavelengths considering a Time and Wavelength Division Multiplexing (TWDM) system for enabling simultaneous transmission of COMP which requires synchronization in the fronthaul, by simultaneously scheduling multiple ONUs in the same slot.

8. The method (200) as claimed in claim 7, wherein the step of allocating with same resource block group to each of the COMP user comprises steps of:
calculating (202) channel gain coefficients (h) for resource blocks groups (RBGs) across multiple Remote Radio Heads (RRHs) for one or more User Equipments (UEs);
ranking (204) the channel gain coefficients in descending order, associating each coefficient with its respective UE, RBG, and RRH indices, and storing the ranking information in a ranking repository;
identifying (206) the highest channel gain for each UE-RRH pair across available RBGs for generating (208) prioritized COMP sets for each UE based on the highest-ranking RRHs;
allocating (210) RBGs to non-COMP users by iteratively evaluating each RRH, leveraging the stored ranking repository to update RBG and UE assignment statuses; and
dynamically allocating (212) RBGs for COMP users by optimizing COMP set assignments based on predefined scheduling criteria and available resources.

9. The method (200) as claimed in claim 8, the step of dynamically allocating RBGs for COMP users comprises the steps of:
analyzing (214) the potential throughput improvement for each COMP set by comparing the respective throughput against existing non-COMP allocations;
prioritizing (216) COMP sets based on the evaluated throughput improvements using a descending ranking order;
sequentially evaluating (218) COMP sets to determine feasibility of selected COMP sets, including checking the association status of RRHs and verifying the time slot and wavelength allocation of the respective ONUs in the fronthaul grid for each of the set;
upon confirming feasibility and positive throughput improvement, updating (220) RBG allocations and RRH assignment statuses; and
updating the final throughput and iteratively processing until all the RBGs are exhausted.
